(19) United States
(12) Patent Application Publication
(10) Pub. No.: US 2018/0324211 A1
(43) Pub. Date: Nov. 8, 2018

(54) SYSTEM AND METHOD FOR PREVENING DENIAL OF SERVICE ATTACKS

(71) Applicant: Manish Doshi, Sunnyvale, CA (US)

(72) Inventor: Manish Doshi, Sunnyvale, CA (US)

(73) Assignee: Manish Doshi, Sunnyvale, CA (US)

(21) Appl. No.: 15/587,990

(22) Filed: May 5, 2017

(51) Int. Cl. H04L 29/06; H04W 12/06; H04L 5/00

(52) U.S. Cl. CPC H04L 63/1458; H04L 63/083; H04L 5/0055; H04W 12/06; H04L 69/16; H04L 63/0853

(57) ABSTRACT

A system for preventing a distributed denial of service (DDoS) attack is disclosed. The system includes a content delivery network (CDN) server connected to Internet, a server connected to the Internet, and a token generator connected to the Internet. The CDN server, the server and the token generator are configured to perform an operation. The operation includes rendering a static login page on a remote computer, receiving entered login information at a token generator through User Datagram Protocol (UDP) from the remote computer, authenticating the received login information by the token generator using an authentication module that is aware of authentication requirements of the server, sending a token and a cookie back to the remote computer, receiving, at the server, a SYN packet with the token from the remote computer, verifying the received token by the web server, and sending an ACK packet back to the remote server from the web server.

### BACKGROUND

When a computer (or a server) is connected to the Internet, it becomes available to be used from practically anywhere in the world by people for the services provided by the server that may include back-end infrastructure such as data stores, file stores and connectivity to other internal and external resources. Pervasiveness of the Internet has changed the way business is conducted and services are rendered to public. Government agencies, banks, educational institutes, private businesses, healthcare providers and so on now provides valuable and critical services to their consumers through the Internet using one or more servers connected to the Internet. For example, days when one must visit a stock broker for buying or selling stocks are in the past. The Internet has made is easy to public to perform these types of activities using their computing devices that connects to the servers of the business providers and execute transactions.

However, because these servers are accessible freely from anywhere in the world, they are prone to attacks by malicious entities and people. One of those attacks involves overwhelming a server so much that the server either slows down considerably or shuts down completely, thereby disrupting its intended use. When a computing device connects to a server, the server allocates resources to serve that computing device. A server has limited resources, hence incoming connection attempts may be queued. A malicious entity may attempt a large number of connections within a short duration of time to grab the resources at the server thus making legitimate connections to wait. In some cases, when a server find it overwhelming to cater to these malicious connections, it may also shutdown thus making it unavailable to legitimate users.

A common type of such attacks is called a distributed denial-of-service (DDoS) attack. The DDoS is an attack in which multiple compromised computer systems attack a target, such as a server, website or other network resource, and cause a denial of service for legitimate users of the targeted resource. The flood of incoming messages, connection requests or malformed packets to the target system forces it to slow down or even crash and shut down, thereby denying service to legitimate users or systems. Methods have been developed to thwart these malicious attacks. However, most of these methods include counting number of connection requests from a same source. This method proves ineffective because it may also thwart legitimate users and malicious entities may use different sources or using spoofed IP addresses to launch a coordinated attack.

Another type of attack is called TCP synchronize (SYN) flood attack. In a SYN flood attack, the attacker sends repeated SYN packets to every port on a targeted server, often using a fake IP address. The server, unaware of the attack, receives multiple, apparently legitimate requests to establish communication. It responds to each attempt with a SYN-ACK packet from each open port. The malicious remote computer either does not send the expected ACK, or if the IP address is spoofed, never receives the SYN-ACK in the first place. Either way, the server under attack will wait for acknowledgement of its SYN-ACK packet for some time. During this time, the server cannot close down the connection by sending an reset (RST) packet, and the connection stays open. Before the connection can time out, another SYN packet will arrive. This leaves an increasingly large number of connections. The server's connection overflow tables fill and services to legitimate users will be denied, or the server may even malfunction or crash.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a system and method for preventing a distributed denial of service (DDoS) attack is disclosed. The system includes a content delivery network (CDN) server connected to Internet, a server connected to the Internet, and a token generator connected to the Internet. The CDN server, the server and the token generator are configured to perform an operation. The operation includes rendering a static login page on a remote computer, receiving entered login information at a token generator through User Datagram Protocol (UDP) from the remote computer, authenticating the received login information by the token generator using an authentication module that is aware of authentication requirements of the server, sending a token and a cookie back to the remote computer, receiving, at the server, a SYN packet with the token from the remote computer, verifying the received token by the web server, and sending an ACK packet back to the remote server from the web server.

In some embodiments, the token is updated by the server periodically at configurable periods and sent to the token generator and the sending the token includes sending the same token in response to all authenticated requests until a new token is received from the server. The server retains at least one immediate previous token for a period and the verifying the received token includes verification with the latest token the server has or verification with the immediate past token. The verification includes comparing the received token with a token retained at the server.

In some embodiments, the login page does not include an address of a server associated with the login information to be entered in the login page and the token generator is configured to send the address back to the remote computer along with the token.

The server may include a kernel module to intercept the SYN packet and the token and verify if the token is valid. The cookie that is returned by the token generator includes authentication information per a requirement set by the server, to enable the remote computer to access services provided by the server.

In some embodiments, instead of sending a token to the server from the remote computer, a hash of the token may be sent along with the SYN packet.

The server is configured to create a session to serve an incoming request only after the kernel module verifies the token.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 shows a system configured to prevent distributed denial of service (DDoS) attacks in accordance with one or more embodiments of the present disclosure;

FIG. 2 depicts a login page configured to communicate with a UDP server and a web server in accordance with one or more embodiments of the present disclosure; and

FIG. 3 shows a block diagram of a method for preventing DDoS attacks in accordance with one or more embodiments of the present disclosure.

Note that figures are not drawn to scale. Intermediate steps between figure transitions have been omitted so as not to obfuscate the disclosure. Those intermediate steps are known to a person skilled in the art.

### DETAILED DESCRIPTION

Many well-known manufacturing steps, components, and connectors have been omitted or not described in details in the description so as not to obfuscate the present disclosure.

For an easy understanding of the embodiments described herein, an Internet based fictitious stock brokerage Internet server will be used in examples. However, a person skilled in the art would appreciate that the embodiments described herein may be used to prevent distributed denial of service (DDoS) attacks on any computer that hosts Internet based services.

There are many communication protocols for enabling computer to computer communications. Among them, Transport Control Protocol (TCP) is primarily used for enabling computer to computer communications over the Internet. TCP is a set of rules that governs the delivery of data over the Internet or other network that uses the Internet Protocol, and sets up a connection between the sending and receiving computers. When a computing device connects to an Internet based server that runs a web server (e.g., Microsoft IIS or Apache server), the server creates what is called a session in its memory. The session is typically a set of resources that are allocated to serve the remote computer. The session remains live for a configurable time and continues to occupy resources even after the connection from a remote computer has ended.

The host server may only have finite amount of resources, there is a limit to how many sessions can exist at a given point in time. In the example of the fictitious stock broker web server, the server includes a set of resources (e.g., computer memory, connection bandwidth, etc.). The host server may also include a connection to a database or a file system for storing a user specific information. In the example of the fictitious stock brokerage, the information may include users' account information, stock holding, etc. The host server may provide a stock buying/selling service to its legitimate users. As it is well known, in a fast moving market, timely execution of stock trades is important. If a DDoS attack slows down the server to cause delays in execution and servicing requests from legitimate users such delays may be detrimental to the legitimate users as well as to the fictitious stock brokerage.

Another communication protocol that is not typically used for general purpose Internet services is User Datagram Protocol (UDP). UDP is an alternative communications protocol to TCP used primarily for establishing low-latency and loss tolerating connections between applications on the Internet. However, unlike a TCP connection, a UDP connection does not create a session in a host server, thus UDP is called a stateless protocol. The host server deallocates resources as soon as a UDP connection ends. Details of these protocols are well known to a person skilled in the art.

The server of the fictitious stock brokerage includes web pages and services to provide stock trading functions to users. The term “server” as used herein may be a group of computers or just one computer. Each of the computer in the server group includes a web server that provides a front end to receiving connection requests from users' computing devices. The web server is electronically connected to a database system that is configured to store users' information and transactions. The web pages include static and dynamic web pages. Static web pages are electronic documents with contents that do not change for different users. On the other hand, dynamic pages are created by the web server individually for each user and these dynamic web pages may include a user's private information. The information is typically retrieved from the database during the creation of a dynamic web page for a user when user logs in and traverse various features provides by the web server. It should be noted that the term “web server” is being used broadly in that the term “web server” can also be an application server connected to the Internet.

Static pages are typically cached by the web server and retrieval of these static pages typically does not include an interaction with the database server. Moreover, these static pages may be hosted separate from the server of the fictitious stock brokerage. Content Delivery Network (CDN) is one such mechanism in which copies of static pages are made and hosted on several external web servers that may be geographically located in different regions. The server that host these static pages typically has a very short session lifetime and are configured to process many simultaneous requests.

An access to user specific dynamic web pages typically starts with a login page in which a user enters his/her user name and password. To avoid having a user to continue to enter user name and password frequent during a configurable period, the session life span is set to a longer duration that could run into tens of minutes or even hours. Thus, once a user logs in, an amount of resources is blocked for a duration of time. In fact, even if a login attempt is unsuccessful, the server will create a session and hold it in the memory.

In a typical scenario, when username/password pair is submitted to the web server, the web server creates a session, interacts with the database to verify the submitted login information and if successfully verified, set some parameters in the session. Hence in this example every login attempt requires a participation of the web server and the database. Now assuming a malicious entity continues to submit fake login credentials repeatedly using a script of program running at a remote computer, this activity may quickly overwhelm the server or even shut it down. These malicious scripts running on thousands of remote computers may create millions of such fake credentials submissions within seconds and continue for a period, thus making the server ineffective to serve its legitimate purpose. The embodiments described herein prevents such occurrences.

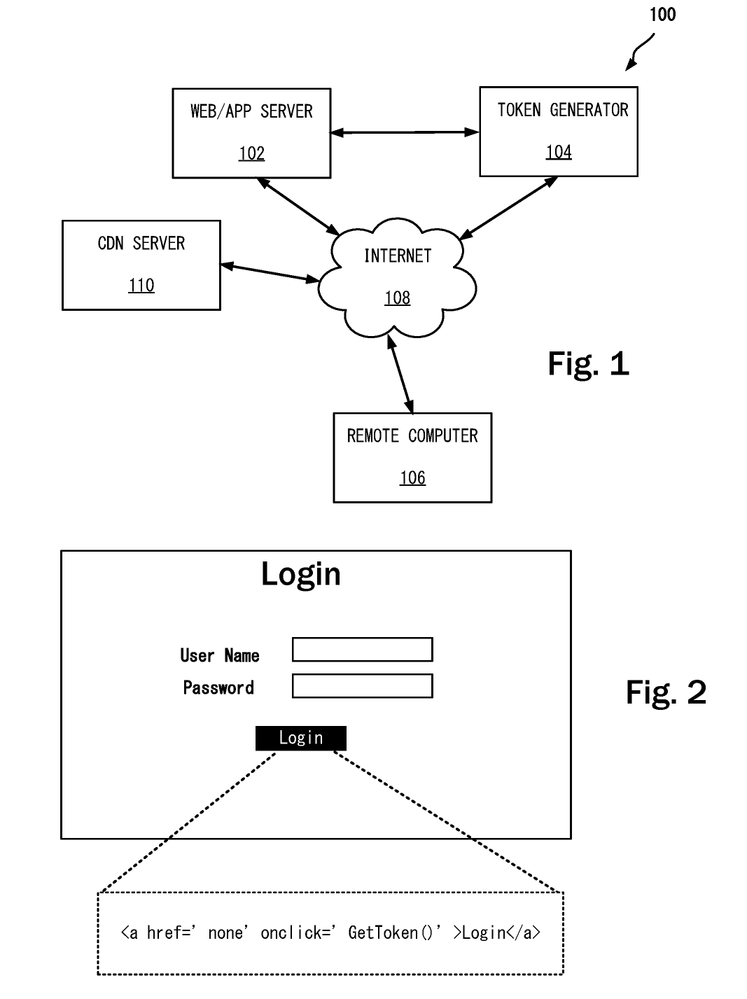

FIG. 1 illustrates a system 100 that is configured to prevent distributed denial of service (DDoS) attacks. The system 100 includes a web server 102 (which can also be an application server) connected to the Internet 108, a token generator 104 connected to the Internet 108 and a remote computer 106 connected to the Internet. The system 100 may also include an authentication module for verifying authentication information against pre-stored data in a persistent database. The authentication mode may be deployed on a separate server or may be deployed on the same server either as the web server 102 or the token generator 104. Still further, in some embodiments, the token generator 104 may be deployed on a same server with the web server 102. However, the token generator 104 will be using a different port to listen to incoming requests. The remote computer 106 may not always be connected to the Internet 108. However, the remote computer 106 may connect to the Internet 108 when a user of the remote computer 106 wishes to interact with the web server 102 to perform some transactions or view information relating to the user. The system 100 may also include a content delivery/distribution network (CDN) server 110. Typically, a CDN is a large distributed system of servers deployed in multiple data centers across the Internet to serve content to end-users with high availability and high performance. Static web pages may be delivered from the CDN server 110 instead of the web server 102. The term “token” as used herein may mean a unique identifier.

In some embodiments, the token generator 104 preferably may reside on a host computer separate from a host computer that hosts the web server 102. In some embodiments, the host computer that hosts the token generator 104 does not accept TCP (or any other stateful protocol that may be used over the Internet) connection requests other than from a selected IP addresses. Such configurations can be made through a firewall software or hardware coupled to the token generator 104.

FIG. 2 shows a sample login page displayed on the remote computer 106, including fields for entering user name and password. The login page also includes a login button or link. The login page is a static web page and delivered by the CDN server 110. The address of the web server 102 may be included in the login button link. However, in some embodiment, to provided added protection, the login button or link does not include the identify or address of the web server 102. The login page may be linked to a TCP/UDP JavaScript application programming interface (API) and in some embodiments, a JavaScript library for encrypting/decrypting data. The login button may also be linked to a JavaScript function (e.g., GetToken( )) that is invoked when the login button is clicked or selected. The login button is does not include the address of the web server 102 in its link. It should be noted that a login page is being used for example only. A person skilled in the art would appreciate that the embodiments described herein may also be used in scenarios without a login page.

When the login button is clicked, the function (e.g., GetToken( )) is invoked. The function encrypts entered user name and password and using the TCP/UDP API, opens a UDP connection to the token generator 104 and send encrypted user name/password to the token generator 104. It may be noted that UDP protocol is being used for example only in that any other stateless communication protocol may be used instead of UDP. It should be noted that the use of JavaScript is being used for example only. In some embodiments, a browser plugin may also be pre-installed on the remote computer 106 to provide functions to establish connections using UDP and encryption features. However, the use of JavaScript may be user friendly in some embodiments because the JavaScript libraries can automatically be linked to the login page when the login page is rendered on the remote computer 106. In some embodiment, the linked JavaScript encryption library may include a key that can be used for encrypting user name and password and the token generator 104 may use the same key to decrypt the received data and vice versa. Data encryption is well known in the art, hence a detailed discussion is being omitted. In some embodiments, a transport layer security (TLS) based encryption mechanism may be used for a secure communication with the token generator 104, as for example Datagram TLS (DTLS) protocol may be used.

After the encrypted user name and password pair is received by the token generator 104, the token generator 104 authenticates the user name and password pair using the authentication module. Upon successful authentication, the token generator 104 return a token and a cookie back to the login page. In one embodiment, the web server 102 generates a new token at a configurable period and sends that token securely to the token generator 104. To account for a network latency, the web server 102 also keeps at least one previous token at least for a period that may be smaller than the period in which a new token is generated and set to the token generator 104. For example, if a new token is generated once every 30 seconds, a previous token may be retained for 2-3 seconds. Therefore, to account for a latency of sending a new token to the token generator 104, for a brief period, the web server 102 may accept requests (as described below) that contain either of the token.

In some embodiments, the token may be generated by the token generator 104 and the token generator 104 sends that token to the web server 102. In some other embodiments, instead of a cookie, the token generator 104 may send the token and address information (e.g., IP address or Web address) of the web server 102. However, in some embodiments, when the address of the web server 102 is already included in the login page, the token generator 104 does not send the address of the web server 102 back to the remote computer 106. If a cookie is send, the cookie may include authentication/authorization data in the format that is acceptable by the web server 102. In some examples, the authentication module may generate the cookie to be sent back to the remote computer 106 based on the requirement of the web server 102. After the function that initiated the UDP connection with the token generator 104 receives the authentication response back from the token generator 104, the function sends a SYN packet to the web server 102. With the SYN packet, the function also sends the received token to the web server 102 over a secure channel such as HTTPS. In some embodiments, instead of sending the token to the web server 102, a hash (e.g., MD5, SHA1, SHA2, etc.) of the token is sent to the web server 102. Since the web server 102 also has the same token, it can create a hash of its own copy of the token and compare with the received hash to verify that the request has been authenticated by the token generator 104.

In some embodiments, the web server 102 does not create a session unless the web server 102 can successfully compare the received token or its hash value. Therefore, requests with bad tokens or hash do not substantially burden the web server 102. To stop the requests coming to the web server 102 and letting them in only after the token verification, a kernel module may be installed in the web server 102. The kernel module is configured to intercept incoming SYN packets, verify the token and send back ACK upon a successful verification of token. If the token is not found or the token is found invalid, no ACK packet is sent back. It should be noted that other security mechanism may be used. For example, the public key infrastructure (PKI) mechanism may be used to encrypt token and other data between the remote computer 106 to/from the token generator 104 and the remote computer 106 to/from the web server 102.

After the remote computer 106 receives ACK packet, the function may use a get or post methods to send the login page (that may include sending the cookie received from the token generator 104) to the web server 102. Since the cookie may include information for the web server 102 to identify the user, the web server 102 then can provide services to the user of the remote computer 106.

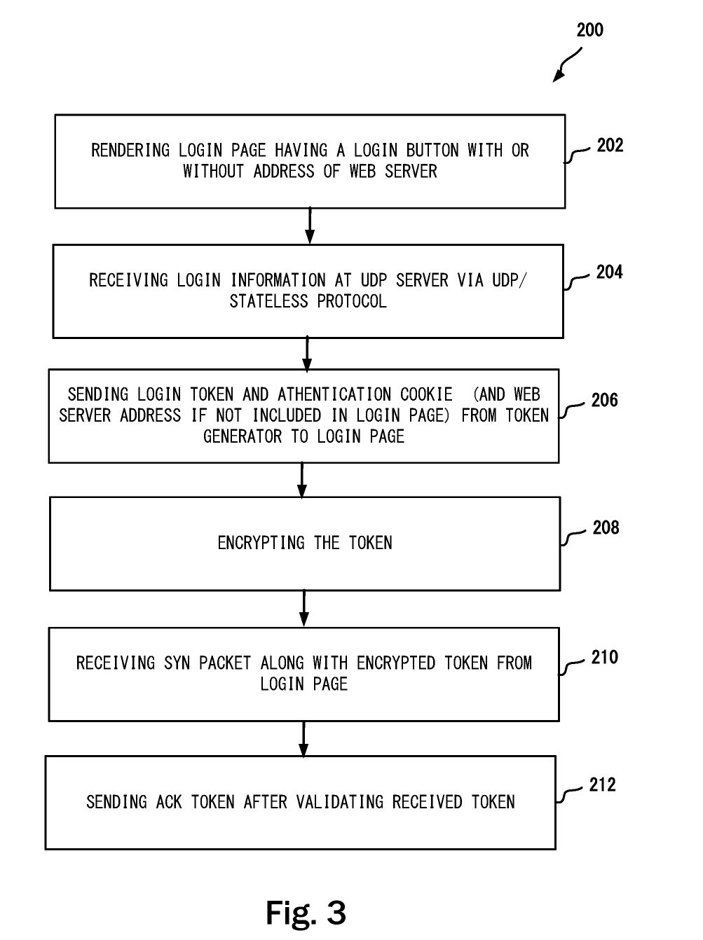

FIG. 3 shows a method 200 for preventing DDoS attacks on the web server 102. Accordingly, at step 202, a login page is rendered on the remote computer 106. The login page is preferably rendered from a CDN server 110. In some embodiments, the login page does not include the address of the web server 102. The login page includes places for the user of the remote computer 106 to enter his/her user name/password pair. At step 204, a JavaScript library or a browser plugin encrypts the entered user name/password pair and send this information to the token generator 104 through UDP protocol. Alternatively, or in addition DTSL protocol may be used to secure communication between the remote computer 106 and the token generator 104. At step 206, the token generator 104 verifies (e.g., with the help of the authentication module) the user name/password pair and upon successful verification, sends a token and the address of the web server 102 (if not already included in the login page) and an authentication cookie back to the remote computer 106. The cookie is generated based on the authentication requirements of the web server 102. When the cookie received from the token generator 104 is set in the remote computer 106, the web server 102 does not require a further authentication, at least for a period, for the remote computer 106 to use services or applications offered by the web server 102. Alternatively, at step 208, the remote computer 106 may generate a cookie (e.g., using the JavaScript library linked to the login page) from the information received form the token generator 104. At step 210, the remote computer 106 sends a SYN packet along with the token to the web server 102. At step 212, the web server 102 verifies the token, as described above, and send ACK packet back to the remote computer 106. After receiving the ACK packet, the remote computer 106 may use services provided by the web server 102.

In some embodiments, the token generator 104 returns a user specific token back to the remote computer 106 instead of returning a same token to all requests within a configurable period. In one example, when a username/password pair is received from the remote computer 106, after the username/password pair is authenticated, the token generator 104 generates a unique token or identifier, sends that unique token to the server 102 (or to the authentication module) and returns the token along with the cookie back to the remote computer 106, as described above. In another example, when a username/password pair is received from the client computer 106 and after the username/password pair is authenticated, the token generator 104 requests the server 102 (or the authentication module) for a unique token for the username. In another example, when the token generator 104 requests the server 102 or the authentication module to authenticate the received username/password pair, in response to a successful authentication, the server 102 or the authentication module returns a unique token. In some embodiments, the unique token specific to the received username may have a limited and configurable life span.

Further, in the embodiments where the address of the server is not includes in the login page, as stated above, the address of the server is supplied by the token generator 104 along with the token and the cookie. Depending on the load, multiple instances of the server 102 may be employed and the token generator 104 may be used to load balance the load among all instances by supplies an address of a server instance say for example, in round robin manner. The token generator 104 may maintain a list of all instances of the server 102 in a lookup table that includes either web addresses or IP addresses of the instances of the server 102. When a new instance of the server 102 is provisioned, the new instance may automatically register its IP address in the lookup table of the token generator 104. Alternatively, this entry in the lookup table may be entered manually. Similarly, there may be multiple instances of the token generator 104 preferably behind a load balancer.

Some or all of these embodiments may be combined, some may be omitted altogether, and additional process steps can be added while still achieving the products described herein. Thus, the subject matter described herein can be embodied in many different variations, and all such variations are contemplated to be within the scope of what is claimed.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for preventing a distributed denial of service (DDoS) attack against a server, the method comprising:
rendering a static login page on a remote computer;
receiving entered login information at a token generator through User Datagram Protocol (UDP) from the remote computer;
authenticating the received login information by the token generator using an authentication module that is aware of authentication requirements of the server;
sending a token and a cookie back to the remote computer;
receiving, at the server, a SYN packet with the token from the remote computer;
verifying the received token by the web server; and
sending an ACK packet back to the remote server from the web server.

2. The method of claim 1, wherein the token is updated by the server periodically at configurable periods and sent to the token generator and the sending the token includes sending the same token in response to all authenticated requests until a new token is received from the server.

3. The method of claim 2, wherein the server retains at least one immediate previous token for a period of time and the verifying the received token includes verification with the latest token the server has or verification with the immediate past token, wherein the verification includes comparing the received token with a token retained at the server.

4. The method of claim 1, wherein the static login page is rendered from a second server that is separate from the web server.

5. The method of claim 1, wherein the login page does not include an address of a server associated with the login information to be entered in the login page and the token generator is configured to send the address back to the remote computer along with the token.

6. The method of claim 1, wherein the server includes a kernel module to intercept the SYN packet and the token and verify if the token is valid.

7. The method of claim 4, wherein the second server is a content delivery network (CDN) server.

8. The method of claim 1, wherein the cookie includes authentication information according to a requirement set by the server, to enable the remote computer to access services provided by the server.

9. The method of claim 1, wherein the receiving at the server includes receiving a hash of the token along with the SYN packet.

10. The method of claim 1, wherein the server is configured to create a session to serve an incoming request only after the kernel module verifies the token.

11. A non-transitory computer readable media comprising programming instructions for preventing a distributed denial of service (DDoS) attack against a server, which when executed by a processor performs an operation, the operation includes:
rendering a static login page on a remote computer;
receiving entered login information at a token generator through User Datagram Protocol (UDP) from the remote computer;
authenticating the received login information by the token generator using an authentication module that is aware of authentication requirements of the server;
sending a token and a cookie back to the remote computer;
receiving, at the server, a SYN packet with the token from the remote computer;
verifying the received token by the web server; and
sending an ACK packet back to the remote server from the web server.

12. The method of claim 11, wherein the token is updated by the server periodically at configurable periods and sent to the token generator and the sending the token includes sending the same token in response to all authenticated requests until a new token is received from the server.

13. The method of claim 12, wherein the server retains at least one immediate previous token for a period and the verifying the received token includes verification with the latest token the server has or verification with the immediate past token, wherein the verification includes comparing the received token with a token retained at the server.

14. The method of claim 11, wherein the login page does not include an address of a server associated with the login information to be entered in the login page and the token generator is configured to send the address back to the remote computer along with the token.

15. The method of claim 11, wherein the server includes a kernel module to intercept the SYN packet and the token and verify if the token is valid.

16. The method of claim 1, wherein the server is configured to create a session to serve an incoming request only after the kernel module verifies the token.

17. A system for preventing a distributed denial of service (DDoS) attack, the system comprising:
a content delivery network (CDN) server connected to Internet;
a server connected to the Internet; and
a token generator connected to the Internet;
wherein the CDN server, the server and the token generator are configured to perform an operation, the operation includes:
rendering a static login page on a remote computer;
receiving entered login information at a token generator through User Datagram Protocol (UDP) from the remote computer;
authenticating the received login information by the token generator using an authentication module that is aware of authentication requirements of the server;
sending a token and a cookie back to the remote computer;
receiving, at the server, a SYN packet with the token from the remote computer;
verifying the received token by the web server; and
sending an ACK packet back to the remote server from the web server.

18. The method of claim 17, wherein the token is updated by the server periodically at configurable periods and sent to the token generator and the sending the token includes sending the same token in response to all authenticated requests until a new token is received from the server.

19. The method of claim 18, wherein the server retains at least one immediate previous token for a period and the verifying the received token includes verification with the latest token the server has or verification with the immediate past token, wherein the verification includes comparing the received token with a token retained at the server.

20. The method of claim 17, wherein the server is configured to create a session to serve an incoming request only after the kernel module verifies the token.
